(19) United States
(12) Patent Application Publication
(10) Pub. No.: US 2007/0034681 A1
(43) Pub. Date: Feb. 15, 2007

(54) Donation collecting system and donation collecting method

(75) Inventors: Hiroshi Kamiya, Osaka-shi (JP); Kunio Ohno, Osaka-shi (JP)

Correspondence Address: YOUNG & THOMPSON, 745 SOUTH 23RD STREET, 2ND FLOOR, ARLINGTON, VA, 22202, US

(73) Assignee: NEC SYSTEM TECHNOLOGIES, LTD., OSAKA-SHI (JP)

(21) Appl. No.: 11/495,459

(22) Filed: Jul. 31, 2006

(30) Foreign Application Priority Data
Aug. 1, 2005 (JP) 2005-222835

(51) Int. Cl. G07F 19/00; G06F 7/08

(52) U.S. Cl. 235/379; 235/381

(57) ABSTRACT

An automatic vending machine included in a donation collecting system includes a donation button and a change button. The donation button is depressed when information indicating that change is treated as a donation is input to the automatic vending machine. The change button is depressed when information indicating that the change is received by a user is input to the automatic vending machine. If the user depresses the donation button, then the automatic vending machine accepts the change as the donation, and transmits donation information on the donation to a company computer through a communication network. Moreover, donees are displayed on a donee display unit so that the user can select one of the donees.

### BACKGROUND OF THE INVENTION

1. Field of the Invention

The present invention relates to a donation collecting system and a donation collecting method for automatically collecting a donation for a social contribution or the like using an automatic vending machine.

2. Description of the Related Art

It has been conventionally normal for an individual, a group or the like to visit a financial institution such as a post office to take steps for donation if the individual, the group or the like intends to make a donation to earthquake sufferers or the like or to a party or the like that offers social contributions.

Recently, as a method of automatically collecting a donation, there is proposed a method of automatically collecting a donation when a user buys a product by displaying an amount of the donation on an automatic vending machine as disclosed in, for example, JP-A 2002-32841.

Furthermore, there is proposed the following method as disclosed in JP-A 2001-351159. Amounts of money of all drinks and food products are set to a fixed amount of money by which change is generated in exchange for one bill or one coin. An automatic vending machine is disposed in a food shop. The automatic vending machine discharges a coin to be replaced by a food product or a drink and a coin corresponding to the change when a user inputs a bill or a coin into the automatic vending machine. The coin corresponding to the change is used as a donation for a social contribution.

With the conventional methods, the change of each user is collected as a donation using the automatic vending machine. The conventional methods, however, requires complicated management of the donations because it is necessary to manage the donations for every automatic vending machine.

### SUMMARY OF THE INVENTION

It is an object of the present invention to provide a donation collecting system and a donation collecting method that can facilitate management of a donation and that enable a user of an automatic vending machine to easily make a donation.

According to a first aspect of the present invention, there is provided a donation colleting system comprising: an automatic vending machine that includes a donation button and a change button, the donation button depressed for inputting information indicating that a change is donated, the change button depressed for inputting information indicating that the change is received by a user; and a company computer that is connected to the automatic vending machine through a communication network, and that collects and manages donation information transmitted from the automatic vending machine, wherein if the donation button is depressed, the automatic vending machine transmits the donation information including an amount of a donation.

According to a second aspect of the present invention, there is provided a donation colleting system comprising: an automatic vending machine that includes a donation button and a change button, the donation button depressed for inputting information indicating that a change is donated, the change button depressed for inputting information indicating that the change is received by a user; and a company computer that is connected to the automatic vending machine through a communication network, and that collects and manages donation information transmitted from the automatic vending machine, wherein if the donation button is depressed, the automatic vending machine transmits the donation information including an amount of a donation and donee information.

According to a third aspect of the present invention, there is provided a donation colleting method using an automatic vending machine that includes a donation button and a change button, the donation button depressed for inputting information indicating that a change is donated, the change button depressed for inputting information indicating that the change is received by a user; and a company computer that is connected to the automatic vending machine through a communication network, and that collects and manages donation information transmitted from the automatic vending machine, wherein if the donation button is depressed, the automatic vending machine transmits the donation information including an amount of a donation.

According to a fourth aspect of the present invention, there is provided a donation colleting method using an automatic vending machine that includes a donation button and a change button, the donation button depressed for inputting information indicating that a change is donated, the change button depressed for inputting information indicating that the change is received by a user; and a company computer that is connected to the automatic vending machine through a communication network, and that collects and manages donation information transmitted from the automatic vending machine, wherein if the donation button is depressed, the automatic vending machine transmits the donation information including an amount of a donation and donee information.

According to the present invention, the automatic vending machine and the company computer are connected to each other by the network, and the company computer manages the donation information transmitted from the automatic vending machine. This can facilitate managing the donation. Furthermore, by displaying donees and enabling the user of the automatic vending machine to select one of the donees, the user can select a desired donee and make a donation to the desired donee. Moreover, because the donees displayed on a plurality of automatic vending machines can be changed by a batch processing, it is possible to flexibly deal with change of donees due to occurrence of a disaster or the like.

### BRIEF DESCRIPTION OF THE DRAWINGS

FIG. 1 is an external view of an automatic vending machine according to an embodiment of the present invention;

FIG. 2 is a schematic of a donation collecting system according to the embodiment;

FIG. 3 is a block diagram of the donation collecting system according to the embodiment; and

FIG. 4 is a flowchart of an operation performed by the donation collecting system according to the embodiment.

### DESCRIPTION OF THE PREFERRED EMBODIMENTS

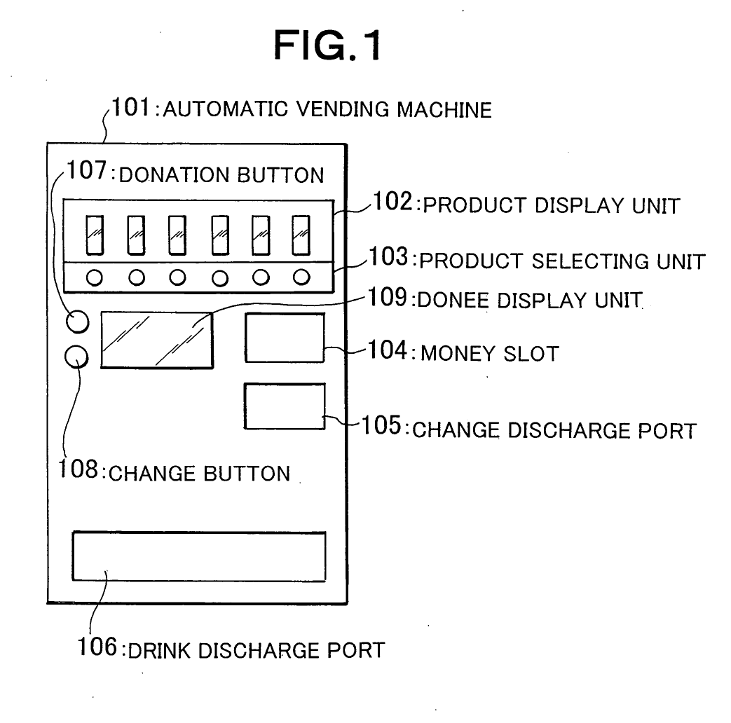

Exemplary embodiments of the present invention will be described hereinafter in detail with reference to the accompanying drawings. FIG. 1 is an external view of an automatic vending machine according to an embodiment of the present invention. In FIG. 1, reference symbol 101 denotes the automatic vending machine for selling, for example, fruit juice drinks, coffee drinks or tea drinks. The automatic vending machine 101 includes a donation collecting function of accepting and collecting a donation from a user. The automatic vending machine that includes the donation collecting function is not limited to the automatic vending machine for beverage but may be an automatic vending machine for food and drinks, tobacco or the like.

Reference symbol 102 denotes a product display unit that displays a name of each drink to be sold such as the name of a juice drink or a tea drink. Reference symbol 103 denotes a product selecting unit that causes a user to select a desired product by depressing a button or the like. Reference symbol 104 denotes a money slot into which the user inputs a coin or a bill. Reference symbol 105 denotes a change discharge port from which change is discharged. Reference symbol 106 denotes a drink discharge port from which the drink which the user buys is discharged. A display unit that displays an amount of the input bill or coin and that displays an amount of the change is not shown in FIG. 1.

Reference symbol 107 denotes a donation button which the user depresses when the user donates the change and reference symbol 108 denotes a change button which depresses when the user does not donate the change. When the user depresses the donation button 107, the change that is the balance of money to be returned to the user by subtracting a price of the product from the input money is processed as a donation and is not returned to the user. When the user depresses the change button 108, the change is discharged from the change discharge port 105 and returned to the user.

Reference symbol 109 denotes a donee display unit that displays donees. For instance, the donee display unit 109 displays donees including sufferers from XX Earthquake or UNESCO. The donee display unit 109 is an electronic display, so that the user can select a desired donee from among a plurality of donees displayed on the donee display unit 109 using a touch panel method or the like. As described later in detail, the donees displayed on the donee display unit 109 can be arbitrarily changed by a company computer connected to the automatic vending machine 101 through a communication network 110.

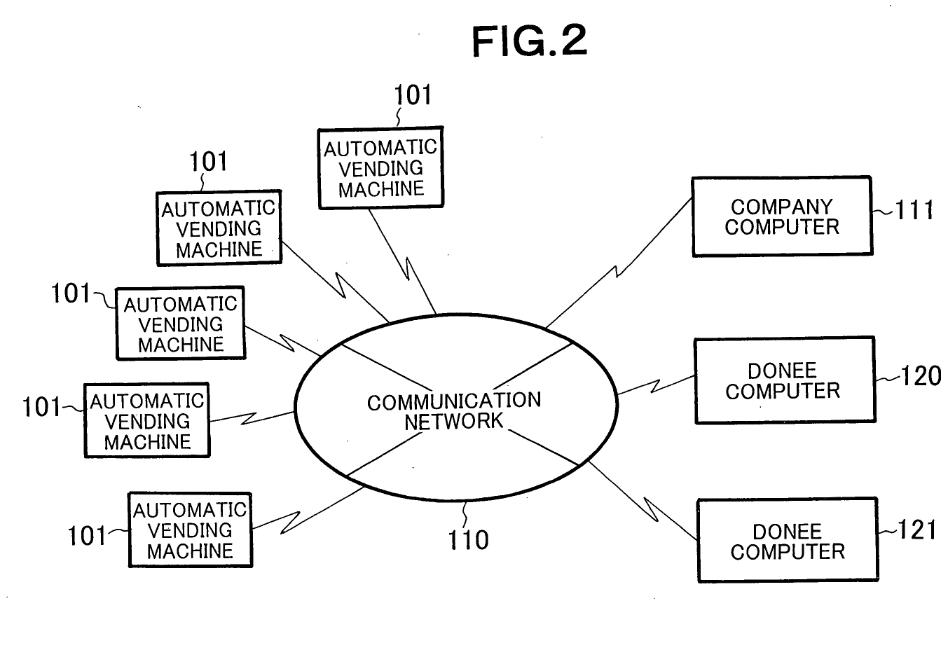

FIG. 2 is a schematic of a donation collecting system according to the embodiment. Each automatic vending machine 101 is connected to the company computer 111 through the communication network 110. The company computer 111 is a computer maintained and managed by a company or an organization involved in raising donations and offering social contributions. Donation information including an amount of each donation, a date of the donation, donee information, and the like is transmitted from each of all the automatic vending machines 101 to the company computer 111 through the communication network 110 at an appropriate time.

The company computer 111 performs collection or the like of the donation information transmitted from each automatic vending machine 101, and makes donation-related management. Moreover, the company computer 111 transmits the donee information to each automatic vending machine 101 through the communication network 110 to cause the donee information to be displayed on the donee display unit 109 of the automatic vending machine 101. As the communication network 110, an arbitrary one of various networks such as the Internet, a telephone line, a power supply line, a wired local area network (LAN), a wireless LAN, and a satellite communication network can be used.

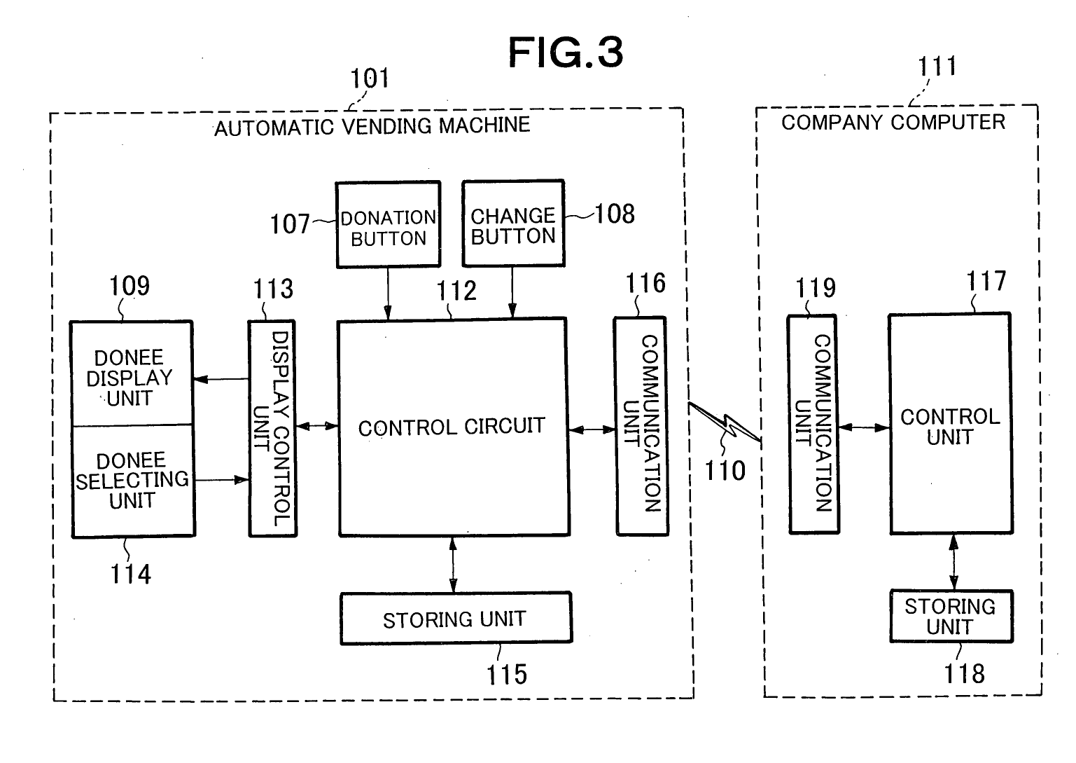

FIG. 3 is a block diagram of the donation collecting system that includes the automatic vending machine 101 and the company computer 111 according to the embodiment. FIG. 3 depicts only important constituent elements of the automatic vending machine 101 for the present invention, and does not depict circuits and mechanisms for product sales.

In FIG. 3, reference symbol 112 denotes a control circuit that includes a central processing unit (CPU), a read-only memory (ROM), a random-access memory (RAM), and the like for controlling respective constituent elements of the automatic vending machine 101, and that operates under control of a program. Reference symbol 116 denotes a communication unit that communicates with the company computer 111 through the communication network 110. The control circuit 112 also controls the communication unit 116 and, therefore, controls a communication of the communication unit 116 with the company computer 111.

Reference symbol 113 denotes a display control unit that controls display units such as the donee display unit 109. Reference symbol 114 denotes a donee selecting unit integral with the donee display unit 109 by the touch panel method or the like. The user can select a desired donee by selecting one donee from among the donees displayed on the donee display unit 109 using the donee selecting unit 114.

The control circuit 112 controls the respective constituent elements of the automatic vending machine 101 to discharge the change when the user depresses the change button 108. When the user depresses the donation button 107, the control circuit 112 accepts the change as a donation. In addition, the control circuit 112 controls a storing unit 115 to store therein the donation information such as a product name, an amount of the donation, a donee, and a donation date. The control circuit 112 transmits the donation information to the company computer 111 whenever the control circuit 112 accepts a donation.

The company computer 111 includes a control unit 117 operating under control of a program, a storing unit 118 that stores therein the donation information and the like, and a communication unit 119 that communicates with the automatic vending machine 101 or the like. The control unit 117 collects the donation information transmitted from each automatic vending machine 101, and controls the storing unit 118 to store therein a sum of amounts of donations per donee.

Moreover, the company computer 111 regularly transmits the donation information to a computer of a corresponding donee. For instance, the company computer 111 transmits the donation information from the communication unit 119 to the donee computer once a week (e.g., on a weekend) or once a month (e.g., on the end of a month). To transmit the donation information, the company computer 111 is connected to donee computers 120 and 121 of respective donees through the communication network 110 as shown in FIG. 2.

To change the donees displayed on the donee display unit 109 of each automatic vending machine 101, the company computer 111 transmits the donee information from the communication unit 119 to all the automatic vending machines 101 through the communication network 110. The donee information displayed on the donee display units 109 of all the automatic vending machines 101 are thereby changed by a batch processing.

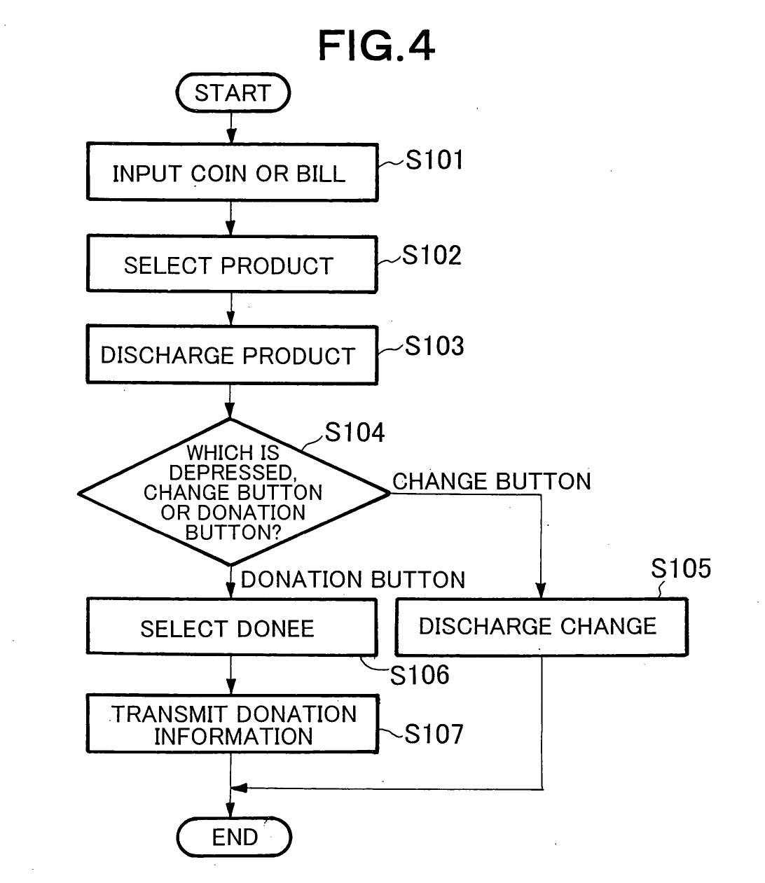

An operation performed by the donation collecting system according to this embodiment will be described with reference to FIGS. 1 to 4. FIG. 4 is a flowchart of the operation performed by the donation collecting system according to this embodiment. First, the user inputs a coin or a bill into the money slot 104 for buying a desired product (S101). It is assumed herein that the user inputs the coin or bill an amount of which is higher than a price of the desired drink (product) which the user buys.

The user selects a drink to be bought on the product selecting unit 103 (S102), and the control circuit 112 controls the respective constituent elements of the automatic vending machine 101 to discharge the selected product from the drink discharge port 106 (S103). Thereafter, the control circuit 112 monitors a button depression signal and determines whether the user depresses the change button 108 or the donation button 107 (S104).

If the user depresses the change button 108, the control circuit 112 discharges the change that is the balance of money to be returned to the user by subtracting the price of the drink from the amount of input money from the change discharge port 105 (S105). The donation collecting system thus finishes the operation.

On the other hand, if the user depresses the donation button 107, the control unit 112 waits for the donee selecting unit 114 to select the donee (S106). If the donee is selected, the control circuit 112 transmits the donation information such as the amount of the donation, the donee, and the donation date from the communication unit 116 to the company computer 111 through the communication network 110. The donation collecting system thus finishes the operation.

In this manner, the company computer 111 totalizes the donation information transmitted thereto from all the automatic vending machines 101, accumulates amounts of donations per donee, and stores the accumulated amounts of donations in the storing unit 118.

If the control circuit 112 determines at the step S104 that the user does not depress either the change button 108 or the donation button 107 for a predetermined time or more after selecting the product, the control circuit 112 may control the change to be automatically discharged. Conversely, the control circuit 112 may process the change as the donation. In the latter case, it is preferable that, when the user does not depress either the change button 108 or the donation button 107 for the predetermined time or more, information indicating that the change is received as a donation is displayed on the automatic vending machine 101. Alternatively, the information may be notified by a voice.

In the embodiment, the donee display unit 109 displays thereon the donees and the user selects one of the donees displayed on the donee display unit 109. Alternatively, the automatic vending machine 101 does not necessarily include the donee display unit 109. In this alternative, if the user depresses the donation button 107 without identifying the donee, the change can be received as a donation. If so, the donee is selected on the part of the company; however, it is preferable that the company discloses donees in advance using the Internet or the like.

Moreover, even if the user of the automatic vending machine 101 does not buy any product, a donation from the user is acceptable. In this case, it is assumed that if the user depresses the donation button 107 without selecting the product, the input money is accepted as a donation.

Furthermore, the automatic vending machine 101 may further include an input device for inputting the amount of a donation so as to receive the input money as the donation. If the amount of the input money is larger than the amount of the donation, the automatic vending machine 101 discharges change. Alternatively, the automatic vending machine 101 may include a function that inputs information such as the name of a donor, the amount of the donation, a donee, and where to make contact using a cellular telephone or a FELICA technology such as “SUICA” (Super Urban Intelligent Card).

1. A donation colleting system comprising:
an automatic vending machine that includes a donation button and a change button, the donation button depressed for inputting information indicating that a change is donated, the change button depressed for inputting information indicating that the change is received by a user; and
a company computer that is connected to the automatic vending machine through a communication network, and that collects and manages donation information transmitted from the automatic vending machine, wherein if the donation button is depressed, the automatic vending machine transmits the donation information including an amount of a donation.

2. The donation collecting system according to claim 1, wherein the company computer regularly transmits the donation information to a computer of a donee.

3. The donation collecting system according to claim 1, wherein the automatic vending machine automatically discharges the change if neither the donation button nor the change button is depressed for predetermined time or more.

4. The donation collecting system according to claim 1, wherein the automatic vending machine processes the change as the donation if neither the donation button nor the change button is depressed for predetermined time or more.

5. The donation collecting system according to claim 1, wherein the automatic vending machine processes input money as the donation if the donation button is depressed but a product to be bought is not selected.

6. The donation collecting system according to claim 1, wherein the automatic vending machine includes input means for inputting the amount of the donation, and receives the donation by as much as the input amount of the donation out of input money.

7. A donation colleting system comprising:
an automatic vending machine that includes a donation button and a change button, the donation button depressed for inputting information indicating that a change is donated, the change button depressed for inputting information indicating that the change is received by a user; and
a company computer that is connected to the automatic vending machine through a communication network, and that collects and manages donation information transmitted from the automatic vending machine, wherein
if the donation button is depressed, the automatic vending machine transmits the donation information including an amount of a donation and donee information.

8. The donation collecting system according to claim 7, wherein the company computer regularly transmits the donation information to a computer of a donee.

9. The donation collecting system according to claim 7, wherein the automatic vending machine automatically discharges the change if neither the donation button nor the change button is depressed for predetermined time or more.

10. The donation collecting system according to claim 7, wherein the automatic vending machine processes the change as the donation if neither the donation button nor the change button is depressed for predetermined time or more.

11. The donation collecting system according to claim 7, wherein the automatic vending machine processes input money as the donation if the donation button is depressed but a product to be bought is not selected.

12. The donation collecting system according to claim 7, wherein the automatic vending machine includes input means for inputting the amount of the donation, and receives the donation by as much as the input amount of the donation out of input money.

13. A donation colleting method using an automatic vending machine that includes a donation button and a change button, the donation button depressed for inputting information indicating that a change is donated, the change button depressed for inputting information indicating that the change is received by a user; and
a company computer that is connected to the automatic vending machine through a communication network, and that collects and manages donation information transmitted from the automatic vending machine, wherein
if the donation button is depressed, the automatic vending machine transmits the donation information including an amount of a donation.

14. The donation collecting method according to claim 13, wherein the company computer regularly transmits the donation information to a computer of a donee.

15. The donation collecting method according to claim 13, wherein the automatic vending machine automatically discharges the change if neither the donation button nor the change button is depressed for predetermined time or more.

16. The donation collecting method according to claim 13, wherein the automatic vending machine processes the change as the donation if neither the donation button nor the change button is depressed for predetermined time or more.

17. The donation collecting method according to claim 13, wherein the automatic vending machine processes input money as the donation if the donation button is depressed but a product to be bought is not selected.

18. The donation collecting method according to claim 13, wherein the automatic vending machine includes input means for inputting the amount of the donation, and receives the donation by as much as the input amount of the donation out of input money.

19. A donation colleting method using an automatic vending machine that includes a donation button and a change button, the donation button depressed for inputting information indicating that a change is donated, the change button depressed for inputting information indicating that the change is received by a user; and a company computer that is connected to the automatic vending machine through a communication network, and that collects and manages donation information transmitted from the automatic vending machine, wherein
if the donation button is depressed, the automatic vending machine transmits the donation information including an amount of a donation and donee information.

20. The donation collecting method according to claim 19, wherein the company computer regularly transmits the donation information to a computer of a donee.

21. The donation collecting method according to claim 19, wherein the automatic vending machine automatically discharges the change if neither the donation button nor the change button is depressed for predetermined time or more.

22. The donation collecting method according to claim 19, wherein the automatic vending machine processes the change as the donation if neither the donation button nor the change button is depressed for predetermined time or more.

23. The donation collecting method according to claim 19, wherein the automatic vending machine processes input money as the donation if the donation button is depressed but a product to be bought is not selected.

24. The donation collecting method according to claim 19, wherein the automatic vending machine includes input means for inputting the amount of the donation, and receives the donation by as much as the input amount of the donation out of input money.
